(19) United States
(12) Patent Application Publication
(10) Pub. No.: US 2010/0179086 A1
(43) Pub. Date: Jul. 15, 2010

(54) Compositions

(75) Inventors: Fabio Corradini, Mira (IT); Fabio D'Amico, Mira (IT); Dora Zamuner, Mira (IT)

Correspondence Address: PARFOMAK, ANDREW N.;NORRIS MCLAUGHLIN & MARCUS PA, 875 THIRD AVE, 8TH FLOOR, NEW YORK, NY, 10022, US

(73) Assignee: Reckitt Benckiser N.V.

(21) Appl. No.: 12/530,343

(22) PCT Filed: Mar. 7, 2008
(86) PCT No.: PCT/GB08/00783

§ 371 Date: Mar. 3, 2010

(30) Foreign Application Priority Data
Mar. 10, 2007 (GB) 0704659.2

(51) Int. Cl. C11D 3/395

(52) U.S. Cl. 510/302; 510/367

(57) ABSTRACT

A structured detergent composition comprises a bleach component. The bleach component has a particle size of less than 150 μm.

The present invention relates to a liquid composition.

Bleaches in detergent compositions are well known. Their presence is necessary to treat stains, especially to remove coloured stains from items being washed.

Typically bleaches comprise peroxide based compounds that produce/release active singlet oxygen in washing liquor. This has been extensively demonstrated as being the chemical species responsible for the bleaching process. Examples of such bleaches include per-salts such as perborate and percarbonate, also organic carbonates are used.

The bleaches are commonly employed in conjunction with a bleach activator (such as TAED) which increase the activity of the bleach at lower washing temperatures (<40° C.)

There is continual pressure upon detergent manufacturers and retailers to produce new products and especially products which are more cost efficient to manufacture (and sell) than those currently available.

Ways in which to achieve this result is the use of less expensive ingredients or to use the current ingredients at a lower but still effective concentration.

PAP (phthalimidoperhexanoic acid) has been used as a bleach in detergent formulations, e.g. as described in EP-A-0 390 387 and EP-A-0 653 485.

PAP is usually manufactured and crystallised from solution in needle shape with the needles having a particle size of greater than 10 μm. Such particles show good stability but result in poor availability of PAP in solution like e.g. in a washing process.

PAP may be stabilised with boron compounds such as described in U.S. Pat. No. 4,100,095. However, for environmental reasons the use of boron is less favoured and preferably avoided. Other stabilisers are discussed in U.S. Pat. No. 4,686,063 which describes fatty peroxyacid and low levels of an exotherm control agent (urea). U.S. Pat. No. 3,770,816 describes diperisophthalic compositions using alkali metal sulfates as exotherm control agents. EP-A-0 816 481 describes peracid granules containing citric acid monohydrate for improved dissolution rates, wherein the citric acid is an exotherm control agent. EP-A-0 852 259 describes granular compositions of PAP and phthalic acid and N-oxides as exotherm control agents.

According to a first aspect of the present invention there is provided a structured detergent composition comprising a bleach component wherein the bleach component has a particle size of less than 150 μm.

Preferably the bleach component has a particle size of less than 120 μm, more preferably less than 150 μm and most preferably less than 60 μm. Generally the bleach component has a particle size of more than 5 μm.

The term “structured liquid detergent composition” as used herein refers to detergent compositions in which the solvent and the detergent active material (bleach component) form a structuring system with solid suspending properties while remaining pourable. One particular form of such a structuring system is where the detergent active materials are dispersions of lamellar droplets in an aqueous phase which contains a building electrolyte. These lamellar droplets are often referred to as an onion-like configuration or layering of surfactant molecules. A more complete description of structured liquid detergents may be found in the publication “Liquid Detergents” by J. C. van de Pas et al., Tenside Surf. Det. 28 (1991) at pages 158-162, the disclosure of which is incorporated herein by reference.

Structured liquid detergent compositions are typically opaque (non-transparent) compositions containing electrolyte builders, one or more surfactants in the form of a multi-lamellar structure (or a layering of surfactant molecules), and which compositions are highly viscous at room temperature, typical, Brookfield viscosities being in the range of about 1,000-25,000 centipoise. In contrast thereto, unstructured liquid detergent compositions are generally clear thin liquids consisting of micellar solutions and having Brookfield viscosities at room temperature of typically from about 1,000 to 1,600 centipoise.

In the case of the present invention preferably the liquid is structured due to the presence of a surfactant, more preferably due to the presence of a combination of surfactants. Preferably the combination of surfactants comprises an anionic surfactant and a nonionic surfactant. Generally the combination of surfactants comprises these two kinds of surfactants in a certain ratio to one another. It is preferred that the ratio is such that the ratio (by weight percent) of anionic surfactant to nonionic surfactant is about 2:1. A suitable content of anionic surfactant (e.g. LAS) is about 8 wt % (e.g. 7.5 wt %) and a suitable content of nonionic surfactant is about 4 wt %.

Optionally a salt may be present to aid the formation of the structured system. A preferred example of a suitable salt is a builder salt, e.g. sodium citrate. It is preferred that such a salt is present in the composition at an amount of about 11%.

We have now found that structured detergent compositions containing bleach component particles having a particle size of less than 150 μm are able to provide excellent bleach activity. One important factor here is that it has been discovered that the structured liquid system is able to suspend materials having a low water solubility (e.g. such as many bleach components) and to do so whilst maintaining a high level of stability of these components. The high level of stability is reflected in the high level of performance of these components when used, e.g. when used in treating a stain. A further reason for this high activity is a result of the ability of bleach component to disperse/dissolve quickly.

In this application the term bleach component is intended to encompass a bleach and/or a bleach activator.

Preferably the composition comprises up to 20 wt % of bleach, more preferably up to 10 wt % and most preferably about 5 wt %.

Preferably the bleach comprises PAP (phthalimidoperhexanoic acid). It has been found that PAP can provide disinfectant activity as well as bleach performance and is effective at low temperatures, e.g. at or below 30° C.

Preferably the composition comprises up to 10 wt % amount of bleach activator.

Preferably the bleach activator comprises DOBA (deconoyloxy benzoic acid). It has been found that DOBA can provide excellent bleach performance on greasy stains.

Alternatively the bleach activator comprises TAED (tetra-acetyl-ethylene-diamine). It has been found that TAED can provide excellent bleach performance on non-greasy stains and is effective at low temperatures, e.g. at or below 30° C.

The composition may be in the form of a single/simple composition, e.g. packaged in a single container. In such a container, where bleach and bleach activator is present, means may be employed t prevent premature interaction of the bleach with the bleach activator.

Alternatively the composition may comprise a plurality of individual portions which may be packaged in a suitable container that permits accommodation of a plurality (e.g. two individual portions). Such a container is described in, for example, European patent application number 04742946.9, the contents of which are incorporated by reference.

In such a container separation of the bleach and bleach activator may be achieved by locating on agent in one chamber of the container and one agent in another chamber of the container.

The composition contained is in the form of a liquid, which may be thickened or gelled if desired. The liquid composition may be non-aqueous or aqueous, for example comprising less than or more than 5% total or free water. The composition may have more than one phase. For example it may comprise an aqueous composition and a liquid composition which is immiscible with the aqueous composition. It may also comprise a liquid composition and a separate solid composition, for example in the form of a ball, pill or speckles.

The composition generally comprises one or more general detergent components. These include conventional detergent composition components, such as surfactants, builders, alkalies, filler, binders, bleaches, bleach catalysts (e.g.

manganese based bleach catalysts), bleach enhancing agents, silver-corrosion inhibiting agents, enzymes, enzyme stabilisers, soil release agents, dye transfer inhibiting agents, optical brighteners (these may be used to the exclusion of dye transfer inhibiting agents), perfumes, colorants, and dyes.

The detergent composition is preferably used in the domestic environment for the washing and treatment of clothes and the washing of hard surfaces including glassware and kitchen ware. The composition may typically be used in domestic laundry and dishwashing operations, including in automatic laundry machines and automatic dishwashers. The composition may take the form of a complete detergent or in the alternative may take the form of a separate additive. In the latter case the additive may used for removing stains on crockery/kitchenware in a separate liquor before the items are washed in a dishwasher. The additive can also be used in a liquor together with either a bleach-free washing agent or a bleach-containing washing agent as a bleach booster.

The excellent solubility of the bleach in the detergent composition is particularly important as most automatic washing machines begin their operation cycle at a relatively low temperature before heating up to a higher temperature. Bleach particles having the particle size above are able to effectively disperse/dissolve before the temperature of the wash liquor is such that the activity of the bleach is compromised.

The detergent composition preferably has no degrading effect on the bleach particles. To achieve this (e.g. in relatively aggressive compositions) the bleach particles may be coated with a protective sheath (e.g. such as a coating).

The detergent composition optionally comprises one or more additional ingredients. These include conventional detergent composition components, such as surfactants, bleaches, bleach enhancing agents, silver-corrosion inhibiting agents, enzymes, enzyme stabilisers, soil release agents, dye transfer inhibiting agents, brighteners, perfumes, colorants, and dyes.

Generally the composition comprises a bleach activator such as TAED. In this regard the composition of the present invention has been found to be particularly useful in that the stability of such a bleach activator is higher in the presence of the DOBA bleach activator particles of the invention. This is particularly noticeable at higher temperatures.

According to a second aspect of the invention there is provided the use of a composition in accordance with the first or second aspect of the invention in a washing (preferably automatic washing process) such as dishwashing or laundry.

Further details and advantages of the invention can be seen from the following examples.

### EXAMPLES

Stability Data

a) The Following Formulation was Test for Stability

| Component | % |
|---|---|
| Water | Balance |
| linear alkylbenzene sulfonate | 7.52 |
| Nonionic Surfactant | 4.00 |
| Sodium Citrate | 11.00 |
| DTPMP | 0.003 |
| TAED | 1.50 |
| DOBA | * |

* present in one formulation tested at a level of 1.50% and absent from a second formulation tested.

The TAED had the following granulometry.

| μm | % |
|---|---|
| >850 | 0.34 |
| >710 | 1.76 |
| >500 | 1.4 |
| >250 | 5.5 |
| >150 | 48.08 |
| >63 | 11.52 |
| >53 | 8.42 |
| >45 | 18.18 |
| <45 | 4.8 |
| Average Size | 130.32 |

The composition was stored at a variety of different temperatures over various storage periods. The composition as tested at the end of the storage periods and the level of TAED was calculated. These results are shown in the table below. The figures in parentheses show the level of TAED present when the DOBA was present in the composition.

| | Time Weeks | | | |
|---|---|---|---|---|
| Temperature | 1 | 2 | 6 | 8 |
| 30 | 90 (93) | 80 (88) | 72 (73.5) | 63 (71.3) |
| 50 | 61 (71) | 8.2 (22.7) | — | — |
| 60 | 5.4 (19.3) | — | — | — |

Clearly it can be seen that with a combination pf DOBA and TAED the stability of the TAED, particularly at higher temperatures is greatly enhanced.

b) The Following Formulations were Tested for Stability

| Component | % | % |
|---|---|---|
| Water | Balance | Balance |
| linear alkylbenzene sulfonate | 7.52 | 7.52 |
| Nonionic Surfactant | 4.00 | 4.00 |
| Sodium Citrate | 11.00 | 11.00 |
| DTPMP | 0.003 | 0.003 |
| TAED | 5.00 | 10.00 |

The composition was stored at a variety of different temperatures over various storage periods. The composition as tested at the end of the storage periods and the level of TAED was calculated. These results are shown in the table below.

Time (Weeks)

| Temperature | TAED (%) | 0 | 1 | 2 |
|---|---|---|---|---|
| 50 | 1.5 | 100 | 70.7 | 8.2 |
| 50 | 5 | 100 | 79.4 | 57 |
| 50 | 10 | 100 | 91.9 | 77.3 |
| 60 | 1.5 | 100 | 5.4 | 0 |
| 60 | 5 | 100 | 70.4 | 0 |
| 60 | 10 | 100 | 81.7 | 0 |

Clearly it can be seen that a higher concentration of TAED is more stable than a lower concentration of TAED.

Performance Data

### Example 1

The following twin-chamber formulations were prepared:

Chamber 1

Formulation

| | A | B | C | D |
|---|---|---|---|---|
| Water | Balance | Balance | Balance | Balance |
| LAS | 7.52 | 7.52 | 7.52 | 7.52 |
| Nonionic Surfactant | 4.00 | 4.00 | 4.00 | 4.00 |
| Sodium Citrate | 11.0 | 11.0 | 11.0 | 11.0 |
| TAED | — | +0.2 g | — | +0.1 g |
| DOBA | — | — | +0.2 g | +0.1 g |

Chamber 2

| | I | II |
|---|---|---|
| Raw Material | % | % |
| Hydrogen Peroxide | 6.500 | 6.500 |
| HEDP | 0.120 | 0.120 |
| C₁₂₋₁₆ Alcohol 7EO | 8.000 | 8.000 |
| C₁₂₋₁₆ Alcohol 3EO | 3.000 | 3.000 |
| C₁₀₋₁₃ Na LAS | 8.500 | 8.500 |
| Fragrance | 0.250 | 0.250 |
| Dye | 0.0008 | 0.0008 |
| Sodium Cumene Sulphonate | 0.520 | 0.520 |
| Dye transfer inhibitor | 0.300 | — |
| Whitening Agent | — | 0.200 |
| Deionised Water | 73.109 | 72.910 |

Formulae I and II are identical with the exception of the inclusion of either a dye transfer inhibitor or a whitening agent.

The performance each of these formulations was evaluated using the following method:

Removal of a greasy stain selected from make-up, lipstick, olive oil and spaghetti sauce was attempted. These stains were standardised stains purchased from commercial sources.

### Performance Example 1

The liquid products above were used on top of a powder detergent (Ariel powder) 30 ml of each chamber was used, this leading to a total amount of 60 ml for the combined chambers.

A block of 4 washing machines was used (Miele washing machines with 7 Kg load, washing cycle cotton 40° C. The washing machine drum is loaded with the standard stains textiles and 3.5 Kg of ballast) and each formulation went into 2 different machines. Each formulation was tested twice to give 2 internal and 2 external replicates for each formulation.

The stain removal performance was evaluated by measuring the stain before and after treatment using an Ultrascan XE Spectrophotometer, from HunterLab.

The Following Results were Obtained:

| Stain: | A | B | C | D |
|---|---|---|---|---|
| Greasy Stains | | | | |
| Make-Up 1 | 71.8 | 70.6 | 74.1 | 73.4 |
| Lipstick 2 | 44.9 | 43.3 | 52.8 | 53.0 |
| Olive oil | 36.0 | 32.6 | 39.0 | 39.3 |
| Spaghetti Sauce | 79.4 | 79.7 | 83.4 | 81.4 |
| Average | 58.0 | 56.6 | 62.4 | 61.8 |
| Bleachable Stains | | | | |
| Coffee | 82.9 | 83.9 | 84.0 | 83.5 |
| Wine | 77.1 | 80.8 | 79.9 | 80.2 |
| Tea | 75.5 | 79.5 | 78.1 | 79.1 |
| Blueberry Juice | 77.7 | 80.3 | 79.8 | 80.7 |
| Ketchup | 80.6 | 81.2 | 85.4 | 82.5 |
| Grass | 65.3 | 68.3 | 77.2 | 74.3 |
| Average | 76.5 | 79.0 | 80.7 | 80.0 |
| Enzymatic stains | | | | |
| Cocoa | 50.2 | 50.7 | 51.9 | 49.0 |
| Blood/milk/ink | 42.4 | 47.4 | 49.0 | 47.3 |
| Average | 46.3 | 49.1 | 50.5 | 48.1 |

In almost all cases the addition of DOBA improved the performance of the TAED on the stain.

### Performance Example 2

The liquid products above were used on top of a liquid detergent (Dash liquid) 30 ml of each chamber was used, this leading to a total amount of 60 ml for the combined chambers.

A block of 4 washing machines was used (Miele washing machines with 7 Kg load, washing cycle cotton 40° C. The washing machine drum is loaded with the standard stains textiles and 3.5 Kg of ballast) and each formulation went into 2 different machines. Each formulation was tested twice to give 2 internal and 2 external replicates for each formulation.

The stain removal performance was evaluated by measuring the stain before and after treatment using an Ultrascan XE Spectrophotometer, from HunterLab.

The Following Results were Obtained:

| | Dash | Dash | Dash | Dash |
|---|---|---|---|---|
| | liquid | liquid + A | liquid + B | liquid + C |
| blueberry juice | 49 | 53 | 53 | 61 |
| peach juice | 74 | 76 | 76 | 77 |
| grass | 53 | 56 | 58 | 58 |
| tea | 59 | 63 | 65 | 67 |
| wine | 64 | 66 | 67 | 70 |
| ketchup | 76 | 76 | 75 | 76 |
| cocoa | 50 | 52 | 54 | 53 |
| chocolate | 68 | 70 | 70 | 71 |
| salad dressing/pigment (cot) | 62 | 65 | 66 | 67 |
| mayonnaise/chlorophyll (cot) | 71 | 72 | 72 | 72 |
| olive oil/carbon black (cot) | 26 | 26 | 27 | 27 |
| lipstick (cot) | 42 | 43 | 45 | 48 |
| make up (cot) | 72 | 74 | 74 | 77 |
| lipstick (p/c) | 39 | 39 | 40 | 42 |
| make up (p/c) | 70 | 71 | 73 | 70 |
| skin grease/pigment (cot) | 65 | 68 | 66 | 68 |
| skin grease/pigment (p/c) | 65 | 71 | 71 | 73 |
| spaghetti sauce with meat | 71 | 71 | 71 | 72 |
| (cot) | | | | |
| motor oil/pigment (cot) | 58 | 64 | 61 | 62 |
| motor oil/pigment (p/c) | 59 | 59 | 61 | 60 |

1. A structured detergent composition comprising a bleach component wherein the bleach component has a particle size of less than 150 μm.

2. A composition according to claim 1, wherein the bleach component is a bleach or a bleach activator.

3. A composition according to claim 2, wherein the composition comprises up to 20 wt % of bleach.

4. A composition according to claim 3, wherein the bleach comprises PAP (phthalimidoperhexanoic acid)

5. A composition according to claim 2, wherein the composition comprises up to 20 wt % amount of bleach activator.

6. A composition according to claim 5, wherein the bleach activator comprises DOBA (deconoyloxy benzoic acid).

7. A composition according to claim 5, wherein the bleach activator comprises TAED.

8. A composition according to claim 1, wherein the composition is in the form of a single composition or a composition packaged in a single container.

9. A composition according to claim 1, wherein the composition comprises a plurality of individual portions.

10. A washing process comprising the step of: utilizing a composition according to claim 1.

11. A washing process according to claim 10, wherein clothes are treated.

12. A washing process according to claim 10, wherein hard surfaces are treated.
